(19) United States
(12) Patent Application Publication
(10) Pub. No.: US 2017/0021588 A1
(43) Pub. Date: Jan. 26, 2017

(54) METHOD FOR MAKING A COMPOSITE BOARD

(71) Applicant: ABET LAMINATI S.P.A., Bra (IT)

(72) Inventor: Dario GASTALDI, Bra (IT)

(21) Appl. No.: 15/125,887

(22) PCT Filed: Mar. 13, 2015
(86) PCT No.: PCT/IB2015/051857

§ 371 Date: Sep. 13, 2016

(30) Foreign Application Priority Data
Mar. 13, 2014 (IT) TO2014A000200

(51) Int. Cl. B32B 5/06; B29C 70/34; B32B 5/12; B29C 70/24

(52) U.S. Cl. CPC B32B 5/06; B29C 70/24; B29C 70/34; B32B 5/12; B29K 2105/0809

(57) ABSTRACT

A method for making a composite board, wherein a layered structure is manufactured, which comprises three three-dimensional fabrics overlapping each other, impregnated with resin and interposed between a pair of detaching sheets. The layered structure is compressed by means of a heated press, so that the resin can spread uniformly. Subsequently, the layered structure is allowed to expand, so that the filaments of the three-dimensional fabrics stretch and arrange themselves substantially perpendicular to the laying planes of the fabric sheets forming the three-dimensional fabrics. After the polymerization of the resin impregnating the layered structure, the latter is taken out of the press and the detaching sheets are removed, thus obtaining a finished board.

### CROSS-REFERENCE TO RELATED APPLICATIONS

This application claims priority of International Application No. PCT/IB2015/051857, entitled METHOD FOR MAKING A COMPOSITE BOARD, filed Mar. 13, 2015, the entire contents of which is being incorporated by reference herein, which claims priority to Italian Patent Application No. TO2014A000200, filed Mar. 13, 2014.

### TECHNICAL FIELD

The present invention relates to a method for making a composite board.

### BACKGROUND ART

European patent EP-B-0591324 describes a method for making a composite board, wherein a three-dimensional fabric formed by two fabric sheets facing each other and interconnected by a plurality of filaments undergoes a impregnation procedure using thermosetting resin. The fabric, which is interposed between a pair of detaching sheets, is arranged in a heated press provided with a lower half mold and an upper half mold, which are closed so as to obtain the compression of the three-dimensional fabric between the detaching sheets and allow the resin to completely permeate the fabric. Furthermore, the heat produced by the half molds helps start the resin polymerization process. Subsequently, the half molds are opened in order to remove the fabric sheets and stretch the filaments.

At the end of the resin polymerization process, the detaching sheets are removed, thus obtaining a board with a simple structure and a reduced weight.

The board manufactured according to the aforesaid patent EP-B-0591324, though, is not able to stand great pressures applied perpendicular to the laying plane of the board itself; for this reason, this board cannot be used to create surfaces on which people can walk (this board is typically used for partition walls).

### DETAILED DESCRIPTION

The object of the present invention is to improve the board described in patent EP-B-0591324, so that it can be used also to create surfaces on which people can walk.

The aforesaid object is reached by the present invention, as it relates to a method for making a layered composite structure characterized in that it comprises the steps of

a) making a layered structure comprising at least the following elements:

at least a first fabric sheet defining a first side of the layered structure;

a first three-dimensional fabric formed by two fabric sheets overlapping each other and interconnected by a plurality of filaments which extend along first rectilinear directions parallel to each other forming first rectilinear inner channels of the three-dimensional fabric parallel to each other and each delimited by the fabric sheets and by facing filaments;

a second intermediate three-dimensional fabric formed by two fabric sheets overlapping each other and interconnected by a plurality of filaments which extend along second rectilinear directions parallel to each other forming second rectilinear inner channels of the three-dimensional fabric parallel to each other and each delimited by the fabric sheets and by facing filaments;

a third intermediate three-dimensional fabric formed by two fabric sheets overlapping each other and interconnected by a plurality of filaments which extend along third rectilinear directions parallel to each other forming third rectilinear inner channels of the three-dimensional fabric parallel to each other and each delimited by the fabric sheets and by facing filaments;

the first and the third direction being substantially parallel to each other so as to form the first and third channels arranged substantially parallel to each other; the second direction forming an angle different from zero with respect to the first and the third direction so as to form second channels arranged transversally with respect to the first and the third channels;

at least a second fabric sheet defining a second side of the layered structure;

b) carrying out the impregnation of the elements of the layered structure using synthetic thermosetting resin;

c) compressing the layered structure with a heated press in such a way that the resin is evenly distributed between the various elements of the layered structure;

d) expanding the previously compressed layered structure opening the press in a controlled manner in such a way that the filaments of the first, second and third three-dimensional fabric stretch and arrange themselves substantially perpendicular to the laying planes of the fabric sheets forming the three-dimensional fabrics;

e) carrying out the polymerization of the resin impregnating the layered structure; and

f) extracting the layered composite structure from the press.

The present invention also relates to a board formed by a layered structure embedded into cured resin comprising at least the following elements interconnected together by the resin:

a first fabric sheet embedded in cured resin and defining a first flat side of the board;

a first three-dimensional fabric embedded in cured resin and formed by two fabric sheets overlapping each other and interconnected by a plurality of hardened filaments which extend along first rectilinear directions parallel to each other forming first rectilinear inner channels of the three-dimensional fabric parallel to each other and each delimited by the fabric sheets and by facing hardened filaments;

a second intermediate three-dimensional fabric embedded in cured resin and formed by two fabric sheets overlapping each other and interconnected by a plurality of hardened filaments which extend along second rectilinear directions parallel to each other forming second rectilinear inner channels of the three-dimensional fabric parallel to each other and each delimited by the fabric sheets and by facing hardened filaments;

a third three-dimensional fabric embedded in cured resin and formed by two fabric sheets overlapping each other and interconnected by a plurality of hardened filaments which extend along third rectilinear directions parallel to each other forming third rectilinear inner channels of the three-dimensional fabric parallel to each other and each delimited by the fabric sheets and by facing hardened filaments;

the first and third channels are arranged substantially parallel to each other and the second channel is arranged transversally, in particular perpendicular, with respect to the first and third channels;

a second fabric sheet embedded in cured resin and defining a second flat side of the board.

### BRIEF DESCRIPTION OF THE DRAWINGS

The invention will now be described with reference to the accompanying drawings, wherein:

FIG. 1 shows a layered structure used according to the present invention for making the composite board; and

FIG. 2 shows, in a perspective view, the composite board made according to the method of the present invention;

FIG. 3 shows a variant o the board of FIG. 1.

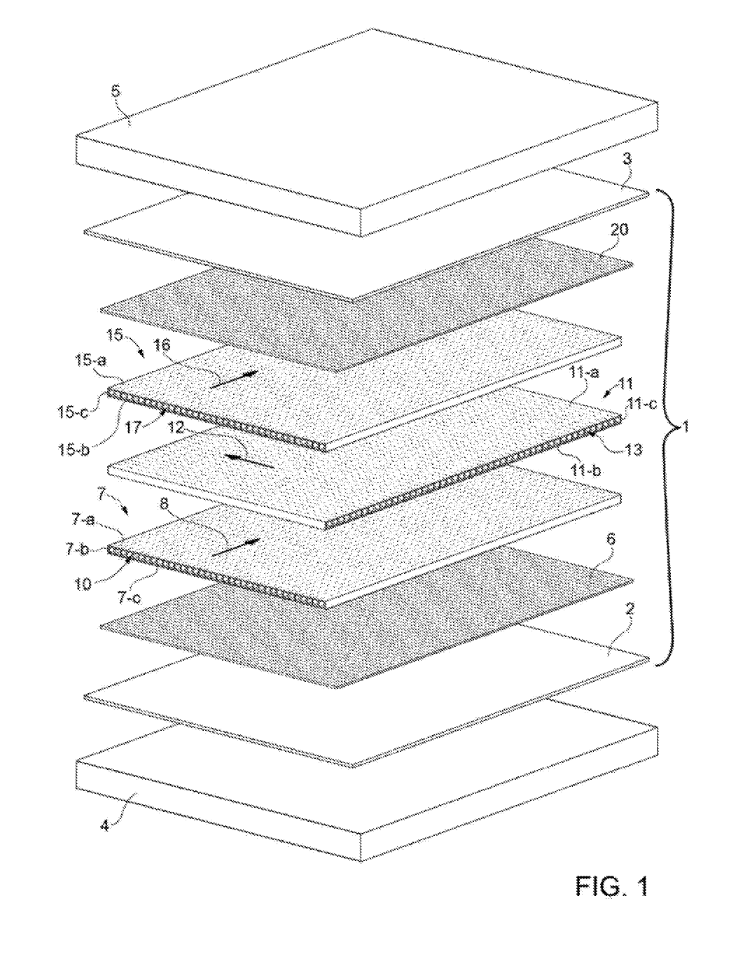

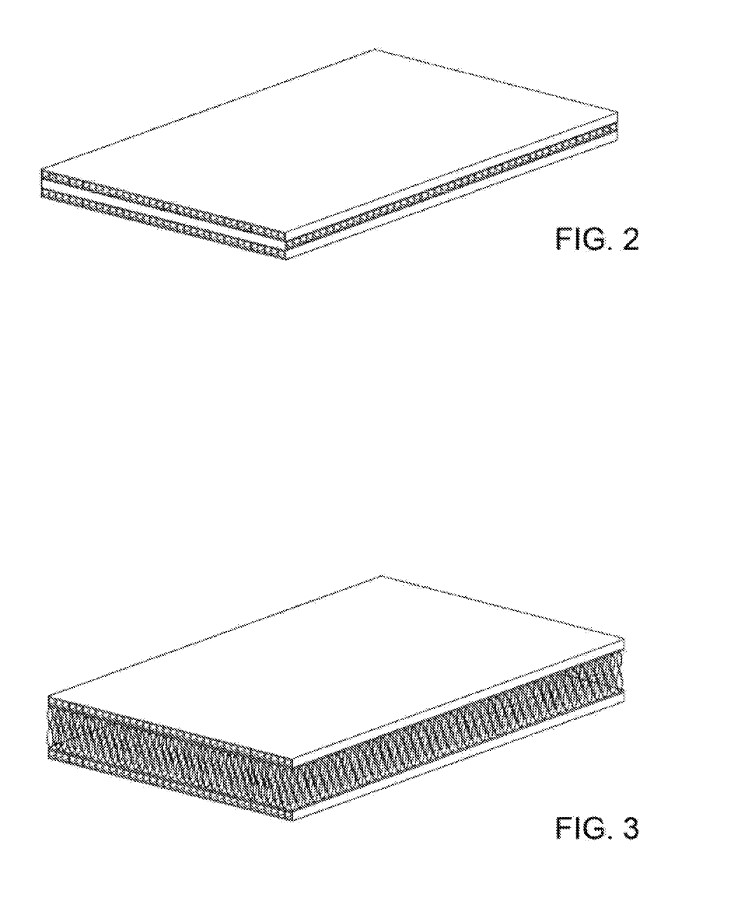

FIG. 1 schematically shows the method according to the present invention for making the board of FIG. 2.

The method of the present invention is used to manufacture a flat layered structure 1, which is made on a working surface (not shown), where the different elements making up the layered structure 1 itself are overlapped. The working surface is also provided with a device (of a known type, not shown), which is designed to pour a liquid thermosetting resin on the different elements making up the layered structure, thus carrying out the impregnation of the layered structure 1.

The layered structure 1, at the end of its formation and impregnation, is interposed between a pair of detaching sheets 2, 3, which are impervious to resin and conveniently made of Mylar. Typically, the sheets 2, 3 have a rectangular perimeter and are larger than the layered structure 1.

The layered structure 1 interposed between the detaching sheets 2, 3 is brought from the working surface (not shown) to a press (schematically and partially shown in FIG. 1), which is provided with a lower half mold 4 and with an upper half mold 5, defining flat rectangular surfaces facing each other and heated at a controlled temperature.

The press carries out a closing step, during which the half molds 4, 5 are closed and the layered structure 1 is compressed so as to allow the resin to uniformly spread among the different elements of the layered structure 1.

As explained more in detail below, the press is reopened, so that the layered structure 1 can expand and, at the same time, harden after the progressive polymerization of the resin.

At the end of the resin polymerization, the layered structure is taken out of the press; subsequently, the detaching sheets are removed, thus obtaining a board that is then sent to a seasoning step, during which the complete cross-linking of the resin takes place.

With reference to FIG. 1, the layered structure 1 comprises at least the following elements, which are listed one after the other starting from the bottom:

at least a first fabric sheet 6 (for example made of glass fibre) defining a first lower side of the layered structure 1;

a first three-dimensional fabric 7 (the three-dimensional fabric, of a known type, is described in European patent EP0816258) formed by two glass fibre fabric sheets 7-a, 7-b overlapping each other and interconnected by a plurality of filaments 7-c which extend along first rectilinear directions 8 parallel to each other and equally spaced apart from each other forming first rectilinear inner channels 10 (the channels typically have a square cross-section) of the three-dimensional fabric 7 parallel to each other and each delimited by the fabric sheets 7-a, 7-b and by facing filaments 7-c;

a second intermediate three-dimensional fabric 11 formed by two glass fibre fabric sheets 11-a, 11-b overlapping each other and interconnected by a plurality of filaments 11-c which extend along second rectilinear directions 12 parallel to each other and equally spaced apart from each other forming second rectilinear inner channels 13 (typically with a square cross-section) of the three-dimensional fabric 11 parallel to each other and each delimited by the fabric sheets 11-a, 11-b and by facing filaments 11-c;

a third intermediate three-dimensional fabric 15 formed by two glass fibre fabric sheets 15-a, 15-b overlapping each other and interconnected by a plurality of filaments 15-c which extend along third rectilinear directions 16 parallel to each other forming third rectilinear inner channels 17 of the three-dimensional fabric 15 parallel to each other and each delimited by the fabric sheets 15-a, 15-b and by facing filaments 15-c;

the first and the third direction 8, 16 are substantially parallel to each other so as to form the first and third channels 10, 17 arranged substantially parallel to each other; the second direction 12 forms an angle different from zero (typically a 90° angle) with respect to the first and the third direction 8, 16 so as to form second channels 13 arranged transversally (typically perpendicular) with respect to the first and the third channels 10, 17;

at least a second glass fibre fabric sheet 20 defining a second upper side of the layered structure 1.

The elements are arranged on the working surface in such a way that they are coplanar to each other, thus forming a flat layered surface 1. Furthermore, a layer of resin is poured on each element before a further element is overlapped; in this way, one can carry out the complete impregnation of the elements of the layered structure using a synthetic thermosetting resin, which coats the glass fiber fabric sheets 20, 15-a, 15-b, 11-a, 11-b, 7-a, 7-b and soaks the filaments 15-c, 11-c and 7-c.

The layered structure 1 is then moved into the press (usually with a translation movement of the working surface) arranging the detaching sheet 2 on the lower half mold 4 and the facing detaching sheet 5 on the upper half mold 5.

The press is closed, so that the layered structure is compressed between the detaching sheets 2, 3 and the resin uniformly spreads among the different elements of the layered structure, thus impregnating the filaments 7-c, 11-c and 15-c in a complete manner.

The press is kept closed for some seconds, so that the resin polymerization process can start and, subsequently, the half molds are moved apart from each other in order to carry out the expansion of the previously compressed layered structure.

In this way, the sheets 7-a and 7b, 11-a and 11-b and 15-a, 15-b separate from each other and the filaments 7-c, 11-c and 15-c straighten up and stretch, arranging themselves substantially perpendicular to the laying planes of the fabric sheets 7-a and 7b, 11-a and 11-b and 15-a, 15-b forming the three-dimensional fabrics.

The layered structure remains in the press for some more seconds, until the resin impregnating the layered structure 1 completes its polymerization.

The layered structure, hardened by the resin, is removed from the press and left to rest for some hours. Subsequently, the detaching sheets are removed, thus obtaining a finished board.

Typically, the board is finished by removing excess material from its sides, so that it has a rectangular perimeter.

The board obtained in this manner is formed by a layered structure embedded into cured resin comprising at least the following elements:

the first glass fibre fabric sheet 6 embedded in cured resin and defining a first flat side of the board;

the first three-dimensional fabric 7 embedded in cured resin and formed by the two glass fibre fabric sheets 7-a, 7-b overlapping each other and interconnected by the hardened filaments 7-c which extend along first rectilinear directions parallel to each other forming the first rectilinear inner channels 10 of the three-dimensional fabric parallel to each other and each delimited by the fabric sheets and by facing hardened filaments;

the second intermediate three-dimensional fabric 11 embedded in cured resin and formed by the two glass fibre fabric sheets 11-a, 11-b overlapping each other and interconnected by a plurality of hardened filaments 11-c which extend along second rectilinear directions parallel to each other forming the second rectilinear inner channels 13 of the three-dimensional fabric parallel to each other and each delimited by the fabric sheets and by facing hardened filaments;

the third three-dimensional fabric 15 embedded in cured resin and formed by the two glass fibre fabric sheets (15-a, 15-b) overlapping each other and interconnected by a plurality of hardened filaments 15-c which extend along third rectilinear directions parallel to each other forming the third rectilinear inner channels 17 of the three-dimensional fabric parallel to each other and each delimited by the fabric sheets and by facing hardened filaments;

the first and third channels 10, 17 are arranged substantially parallel to each other and the second channel 13 is arranged transversally (in particular perpendicular) with respect to the first and third channels 10, 15;

the second glass fibre fabric sheet 20 embedded in cured resin and defining a second flat side of the board.

The board described above has a series of advantages compared to the boards of the prior art:

the board described above has an extremely robust structure, which is able to even stand concentrated loads—for this reason the board can advantageously be used to build the floors of a train or a ship, for example;

the board defines inner cavities (the channels 13) that can convey fluids (e.g. air) used to heat/cool the room in which the board is installed—these channels 13 are not easily accessible from the opposite sides of the board, thus ensuring a safe transportation of the fluids.

According to a variant of the invention shown in FIG. 3, the intermediate three-dimensional fabric can be different from the one described above, namely it can comprise two glass fibre fabric sheets 11-a, 11-b overlapping each other and interconnected by a plurality of filaments 11-c which extend between the fabric sheets forming eight-shaped filament interconnection bridges.

After the opening of the press, the filaments 8c stretch and assume the typical eight shape. Therefore, the intermediate three-dimensional fabric defines a single chamber (the eight-shaped elements are spaced apart from each other and cannot define dividing walls), in which the heating/cooling fluid can circulate.

1-5. (canceled)

6. A method for making a layered composite structure comprising the steps of
a) making a layered structure comprising at least the following elements:
at least a first fabric sheet defining a first side of the layered structure;
a first three-dimensional fabric formed by two fabric sheets overlapping each other and interconnected by a plurality of filaments that extend along first rectilinear directions parallel to each other forming first rectilinear inner channels of the three-dimensional fabric parallel to each other and each delimited by the fabric sheets and by facing filaments;
a second intermediate three-dimensional fabric formed by two fabric sheets overlapping each other and interconnected by a plurality of filaments that extend along second rectilinear directions parallel to each other forming second rectilinear inner channels of the three-dimensional fabric parallel to each other and each delimited by the fabric sheets and by facing filaments;
a third intermediate three-dimensional fabric formed by two fabric sheets overlapping each other and interconnected by a plurality of filaments that extend along third rectilinear directions parallel to each other forming third rectilinear inner channels of the three-dimensional fabric parallel to each other and each delimited by the fabric sheets and by facing filaments;
the first and the third direction being substantially parallel to each other so as to form the first and third channels arranged substantially parallel to each other; the second direction forming an angle different from zero with respect to the first and the third direction so as to form second channels arranged transversally with respect to the first and the third channels;
at least a second fabric sheet defining a second side of the layered structure;
b) impregnating the elements of the layered structure using a synthetic thermosetting resin;
c) compressing the layered structure with a heated press and evenly distributing the synthetic thermosetting resin between the various elements of the layered structure;
d) expanding the compressed layered structure of step c) by opening the press in a controlled manner in such a way that the filaments of the first, second and third three-dimensional fabric stretch and arrange themselves substantially perpendicular to the laying planes of the fabric sheets forming the three-dimensional fabrics;
e) polymerizing the synthetic thermosetting resin impregnating the layered structure; and
f) extracting the layered composite structure from the press.

7. A method according to claim 6, wherein the layered structure is arranged between a pair of detaching sheets impervious to the resin, which are pressed by opposite half molds of said press in said step c);
said method further comprising the step of:
e) removing said detaching sheets from the layered structure after completely curing of said resin.

8. A method according to claim 6, wherein the second direction forms an angle of 90° with respect to the first and third direction so as to form second channels arranged perpendicular to the first and the third channels.

9. A board made according to the method of claim 6.

10. A board made according to the method of claim 7.

11. A board made according to the method of claim 8.

12. A board formed by a layered structure embedded into cured resin comprising at least the following elements interconnected together by the resin:
a first fabric sheet embedded in cured resin and defining a first flat side of the board;
a first three-dimensional fabric embedded in cured resin and formed by two fabric sheets overlapping each other and interconnected by a plurality of hardened filaments that extend along first rectilinear directions parallel to each other forming first rectilinear inner channels of the three-dimensional fabric parallel to each other and each delimited by the fabric sheets and by facing hardened filaments;
a second intermediate three-dimensional fabric embedded in cured resin and formed by two fabric sheets overlapping each other and interconnected by a plurality of hardened filaments that extend along second rectilinear directions parallel to each other forming second rectilinear inner channels of the three-dimensional fabric parallel to each other and each delimited by the fabric sheets and by facing hardened filaments;
a third three-dimensional fabric embedded in cured resin and formed by two fabric sheets overlapping each other and interconnected by a plurality of hardened filaments that extend along third rectilinear directions parallel to each other forming third rectilinear inner channels of the three-dimensional fabric parallel to each other and each delimited by the fabric sheets and by facing hardened filaments;
the first and third channels are arranged substantially parallel to each other and the second channel is arranged transversally with respect to the first and third channels; and
a second fabric sheet embedded in cured resin and defining a second flat side of the board.

13. The board of claim 12, wherein, the first and third channels are arranged substantially parallel to each other and the second channel is arranged perpendicular with respect to the first and third channels.

14. A board formed by a layered structure embedded into cured resin comprising at least the following elements interconnected together by the resin:
a first fabric sheet embedded in cured resin and defining a first flat side of the board;
a first three-dimensional fabric embedded in cured resin, the first three-dimensional fabric comprising two fabric sheets overlapping each other and interconnected by a plurality of hardened filaments that extend along first rectilinear directions parallel to each other forming first rectilinear inner channels of the three-dimensional fabric parallel to each other and each delimited by the fabric sheets and by facing hardened filaments;
a second intermediate three-dimensional fabric embedded in cured resin, the second intermediate three-dimensional fabric comprising two fabric sheets overlapping each other and interconnected by a plurality of hardened filaments that extend along second rectilinear directions parallel to each other forming second rectilinear inner channels of the three-dimensional fabric parallel to each other and each delimited by the fabric sheets and by facing hardened filaments;
a third three-dimensional fabric embedded in cured resin, the third three-dimensional fabric comprising two fabric sheets overlapping each other and interconnected by a plurality of hardened filaments that extend along third rectilinear directions parallel to each other forming third rectilinear inner channels of the three-dimensional fabric parallel to each other and each delimited by the fabric sheets and by facing hardened filaments;
the first and third channels are arranged substantially parallel to each other and the second channel is arranged transversally with respect to the first and third channels; and
a second fabric sheet embedded in cured resin and defining a second flat side of the board.

15. The board of claim 14, wherein, the first and third channels are arranged substantially parallel to each other and the second channel is arranged perpendicular with respect to the first and third channels.
